(19) United States
(12) Patent Application Publication
(10) Pub. No.: US 2021/0216932 A1
(43) Pub. Date: Jul. 15, 2021

(54) NON-TRANSITORY COMPUTER-READABLE RECORDING MEDIUM STORING ENERGY SYSTEM OPTIMIZATION PROGRAM, ENERGY SYSTEM OPTIMIZATION METHOD, AND ENERGY SYSTEM OPTIMIZATION DEVICE

(71) Applicant: IHI Corporation, Tokyo (JP)

(72) Inventors: Yuji KOGUMA, Tokyo (JP); Akinobu INAMURA, Tokyo (JP); Masakazu FUJII, Tokyo (JP)

(73) Assignee: IHI Corporation, Tokyo (JP)

(21) Appl. No.: 17/128,649

(22) Filed: Dec. 21, 2020

Related U.S. Application Data
(63) Continuation of application No. PCT/JP2019/025358, filed on Jun. 26, 2019.
(60) Provisional application No. 62/689,853, filed on Jun. 26, 2018.

(51) Int. Cl. G06Q 10/06; G06Q 10/00; G06Q 50/06; G06Q 30/02; G05B 19/042; G06N 5/02; H02J 3/38

(52) U.S. Cl. CPC G06Q 10/06313; G06Q 10/20; G06Q 50/06; G06Q 30/0206; H02J 2300/24; G06N 5/02; H02J 3/381; G05B 2219/2639; H02J 2300/28; G05B 19/042

(57) ABSTRACT

A non-transitory computer-readable recording medium stores an energy system optimization program causing a computer to execute processes of predetermined steps, the steps including an input step of designating a plurality of types of energy facilities configuring an energy system, a calculation step of acquiring at least one of an optimal system configuration and an optimal operation pattern for which a predetermined index is minimal among at least one of system configurations and operation patterns of the energy system satisfying a predetermined demand, and an output step of outputting the at least one of the optimal system configuration and the optimal operation pattern.

### CROSS-REFERENCE TO RELATED APPLICATIONS

This application is a Continuation Application based on International Application No. PCT/JP2019/025358, filed on Jun. 26, 2019, which claims priority on U.S. Patent Application No. 62/689,853, filed on Jun. 26, 2018, the contents of which are incorporated herein by reference.

### TECHNICAL FIELD

The present disclosure relates to a non-transitory computer-readable recording medium storing an energy system optimization program, an energy system optimization method, and an energy system optimization device.

### BACKGROUND

The following Patent Document 1 discloses a charging/discharging control method for an energy storage facility in an energy storage system using a computer, a computer-readable recording medium storing execution codes causing a computer to execute charging/discharging control of the energy storage facility, and a charging/discharging control system for the energy storage facility. An object of this background technology is to acquire a charging/discharging strategy for an energy storage facility capable of maximizing an economic value of energy storage on the basis of historical data and prediction data, first and second physical models, economic incentive information, constraint conditions of the energy storage system, the configuration of the energy storage system, a cost model, and the like by using a computer.

### DOCUMENT OF RELATED ART

### Patent Document

[Patent Document 1] U.S. Pat. No. 9,509,176

### SUMMARY

As energy facilities configuring an energy system, there are various types of facilities in addition to the energy storage facility described above, for example, various power generation facilities and energy conversion facilities such as a water electrolysis apparatus. In many cases, in the energy system, such various types of energy facilities are combined and operated. However, the background technology described above handles only energy storage facility, and handling of an energy system including a plurality of types of energy facilities is not taken into account.

The present invention has been made in view of the above-described circumstances, and an object thereof is to provide an energy system optimization technology capable of handling an energy system including a plurality of types of energy facilities.

A first aspect of the present disclosure is a non-transitory computer-readable recording medium storing an energy system optimization program causing a computer to execute processes of predetermined steps, the steps including: an input step of designating a plurality of types of energy facilities configuring an energy system; a calculation step of acquiring at least one of an optimal system configuration and an optimal operation pattern for which a predetermined index is minimal among at least one of system configurations and operation patterns of the energy system satisfying a predetermined demand; and an output step of outputting the at least one of the optimal system configuration and the optimal operation pattern.

According to a second aspect of the present disclosure, a non-transitory computer-readable recording medium is provided in which, in the first aspect, the optimal operation pattern is acquired by solving an optimization problem including an objective function representing a minimum of the index and predetermined constraint conditions in the calculation step, and the objective function and the constraint conditions are designated in the input step.

According to a third aspect of the present disclosure, a non-transitory computer-readable recording medium is provided in which, in the second aspect, a system cost is used as the index.

According to a fourth aspect of the present disclosure, a non-transitory computer-readable recording medium is provided in which, in the third aspect, the system cost is a weighted sum of an initial cost and a running cost of the energy system.

According to a fifth aspect of the present disclosure, a non-transitory computer-readable recording medium is provided in which, in the fourth aspect, the running cost is a weighted sum of a maintenance cost of the energy system and a resource cost relating to at least one of an input resource input to the energy system and an output resource output from the energy system.

According to a sixth aspect of the present disclosure, a non-transitory computer-readable recording medium is provided in which, in any one of the second to fifth aspects, the constraint conditions include the following Equation (1) that is formed from an amount U of input of a resource input to the energy system, an amount G of generation of a resource generated by the energy facility, an amount S of consumption of a resource consumed by the energy facility, an amount J of demand for a resource for the energy system, and an amount O of output of a resource to outside of the energy system.

[Math. 1]

U+G=S+J+O (1)

According to a seventh aspect of the present disclosure, a non-transitory computer-readable recording medium is provided in which, in any one of the first to sixth aspects, the energy facility is designated by performing at least one of selection of energy facilities registered in advance and setting of a consumption resource and a generation resource of a new energy facility and a characteristic value relating to the consumption resource and the generation resource in the input step.

According to an eighth aspect of the present disclosure, a non-transitory computer-readable recording medium is provided in which, in the seventh aspect, the characteristic value of the energy facilities registered in advance is changeable in the input step.

According to a ninth aspect of the present disclosure, a non-transitory computer-readable recording medium is provided in which, in any one of the first to eighth aspects, time variations of a resource input to the energy system and a demand for the energy system are output for a predetermined period of the energy facility and a plurality of unit periods in the predetermined period in the output step, and the predetermined period and the unit period are further input in the input step.

According to a tenth aspect of the present disclosure, a non-transitory computer-readable recording medium is provided in which, in any one of the first to ninth aspects, among the plurality of types of energy facilities designated in the input step, an energy facility included in the optimal system configuration and an energy facility not included in the optimal system configuration are output in different forms in the output step.

According to an eleventh aspect of the present disclosure, a non-transitory computer-readable recording medium is provided in which, in any one of the first to tenth aspects, a shadow price for the demand is further output in the output step.

According to a twelfth aspect of the present disclosure, a non-transitory computer-readable recording medium is provided in which, in any one of the first to eleventh aspects, two or more types of energy facilities among an energy generation facility generating various forms of energy, an energy conversion facility converting a certain form of energy into a different form of energy, and an energy storage facility internally storing energy supplied from outside are designated in the input step.

A thirteenth aspect of the present disclosure is an energy system optimization method including: an input process of designating a plurality of types of energy facilities configuring an energy system; a calculation process of acquiring at least one of an optimal system configuration and an optimal operation pattern for which a predetermined index is minimal among at least one of system configurations and operation patterns of the energy system satisfying a predetermined demand; and an output process of outputting the at least one of the optimal system configuration and the optimal operation pattern.

A fourteenth aspect of the present disclosure is an energy system optimization device including: at least one memory storing instructions and at least one processor configured to execute the instructions to: designate a plurality of types of energy facilities configuring an energy system; acquire at least one of an optimal system configuration and an optimal operation pattern for which a predetermined index is minimal among at least one of system configurations and operation patterns of the energy system satisfying a predetermined demand; and output the at least one of the optimal system configuration and the optimal operation pattern.

According to the present disclosure, an energy system optimization technology capable of handling an energy system including a plurality of types of energy facilities can be provided.

### BRIEF DESCRIPTION OF DRAWINGS

FIG. 1 is a block diagram illustrating the configuration of an energy system optimization system according to an embodiment of the present disclosure.

FIG. 2 is a schematic diagram illustrating an energy system according to the embodiment of the present disclosure.

FIG. 3 is a schematic diagram illustrating an energy facility according to the embodiment of the present disclosure.

FIG. 4 is a flowchart illustrating a basic operation of the energy system optimization system according to the embodiment of the present disclosure.

FIG. 5A is a schematic diagram illustrating a first designation screen for energy facilities according to the embodiment of the present disclosure.

FIG. 5B is a schematic diagram illustrating a second designation screen for an energy facility according to the embodiment of the present disclosure.

FIG. 6 is a schematic diagram illustrating a calculation condition input screen according to the embodiment of the present disclosure.

FIG. 7 is a schematic diagram illustrating a system cost (total cost) according to the embodiment of the present disclosure.

FIG. 8 is a schematic diagram illustrating a resource balance of the energy system according to the embodiment of the present disclosure.

FIG. 9 is a schematic diagram illustrating one example of an optimal system configuration according to the embodiment of the present disclosure.

FIG. 10 is a schematic diagram illustrating one example of an optimal operation pattern according to the embodiment of the present disclosure.

### DESCRIPTION OF EMBODIMENTS

Hereinafter, an embodiment of the present disclosure will be described with reference to the drawings.

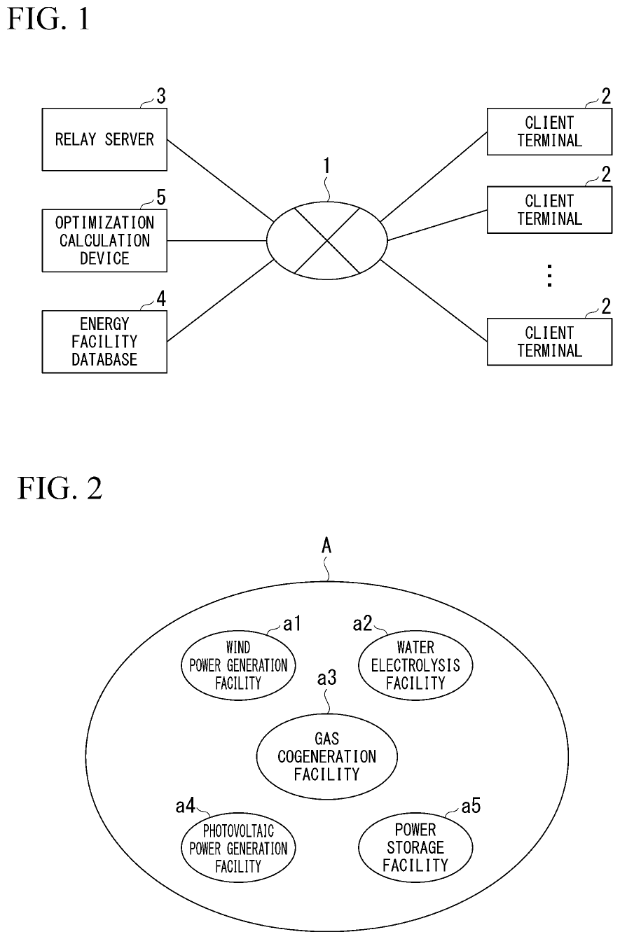

This embodiment relates to a case in which the present disclosure is applied to an information providing service for members using a network and is configured by an energy system optimization system illustrated in FIG. 1.

An optimization target of this energy system optimization system is an energy system including a plurality of types of energy facilities. For example, the energy facilities described above can be classified into three types. A first type is an energy generation facility (Renewable) that generates various forms of energy.

A second type is an energy conversion facility (Converter) that converts a certain form of energy into another form of energy. A third type is an energy storage facility (Storage) that internally stores energy supplied from outside. The energy system as an optimization target includes at least two or more of the plurality of types of energy facilities.

Examples of the energy generation facility include various kinds of power generation facilities for thermal power generation, nuclear power generation, wind power generation, photovoltaic power generation, and the like. Examples of the energy conversion facility include facilities, such as a water electrolysis facility and a gas cogeneration facility, which use electric power (electrical energy), a fuel gas (chemical energy), and the like to generate hydrogen (chemical energy), hot water (thermal energy), and the like. Examples of the energy storage facility include various kinds of storage batteries directly storing electric power (electrical energy), a flywheel storing electric power by converting electric power (electrical energy) into kinetic energy, and the like.

FIG. 2 illustrates an example of the configuration of an energy system A. This energy system A includes a wind power generation facility a1 (an energy generation facility: Renewable), a water electrolysis facility a2 (an energy conversion facility: Converter), a gas cogeneration facility a3 (an energy conversion facility: Converter), a photovoltaic power generation facility a4 (an energy generation facility: Renewable), and a power storage facility a5 (an energy storage facility: Storage).

In the description to be presented below, the wind power generation facility a1 (an energy generation facility: Renewable), the water electrolysis facility a2 (an energy conversion facility: Converter), the gas cogeneration facility a3 (an energy conversion facility: Converter), the photovoltaic power generation facility a4 (an energy generation facility: Renewable), and the power storage facility a5 (an energy storage facility: Storage), which are constituent elements of the energy system A, will be collectively referred to as an energy facility “a”. The energy facility “a” is a facility that performs at least one of consumption of a predetermined resource and generation of a predetermined resource.

The present disclosure may be implemented by installing an energy system optimization program according to the present disclosure in one computer (a standalone computer) that does not basically communicate with the outside. This computer includes a central processing unit (CPU; processor), a storage device, an input/output device, and the like. The storage device includes one or more of a volatile memory such as a random access memory (RAM), a nonvolatile memory such as a read only memory (ROM), a hard disk drive (HDD), a solid state drive (SSD), and the like. The input/output device exchanges signals and data with external input device and output device in a wired or wireless manner. Examples of the input device include a keyboard, a mouse, a touch panel, and the like. Examples of the output device include a display, a printer, and the like. The computer can achieve a predetermined function to be described below on the basis of a program stored in the storage device.

In the energy system optimization system according to this embodiment, in order to provide the present disclosure at a low price for many users, the functions of the energy system optimization program are dispersively mounted in a plurality of information communication devices on a network to provide the present disclosure for users as one information providing service in the network.

As illustrated in FIG. 1, the energy system optimization system includes a communication network 1 corresponding to the network described above, a plurality of client terminals 2 corresponding to the plurality of information communication devices described above, a relay server 3, an energy facility database 4, and an optimization calculation device 5. This energy system optimization system corresponds to an energy system optimization device according to the present disclosure.

Among the constituent elements described above, the communication network 1, the plurality of client terminals 2, and the relay server 3 configure an input unit and an output unit of the energy system optimization device according to the present disclosure. In other words, the communication network 1, the plurality of client terminals 2, and the relay server 3 are constituent elements that execute an input step and an output step in the energy system optimization program according to the present disclosure and are also constituent elements that execute an input process and an output process in an energy system optimization method according to the present disclosure.

In addition, the optimization calculation device 5 according to this embodiment corresponds to a calculation unit of the energy system optimization device according to the present disclosure. In other words, the optimization calculation device 5 is a constituent element that executes a calculation step in the energy system optimization program according to the present disclosure and is also a constituent element that executes a calculation process in the energy system optimization method according to the present disclosure.

Here, the energy system optimization program according to the present disclosure is a program that causes a computer to execute processes of predetermined steps, details of which will be described below, and the steps include the input step, the calculation step, and the output step.

In this embodiment, among three element programs of the input program, the calculation program, and the output program respectively corresponding to the input step, the calculation step, and the output step in the energy system optimization program, the input program and the output program are generated as one program module (a first module) and are stored in a predetermined recording medium. In addition, the calculation program is generated as a program module (a second module) different from the program module described above and is stored in a predetermined recording medium.

A packaging form of the recording medium is not particularly limited, and, for example, the recording medium may be a USB memory or any one of various memory cards. The energy system optimization program according to the present disclosure may be downloaded from a file server as a providing source and be installed in a computer. The recording medium according to this embodiment includes a concept of a storage area of the file server in which the energy system optimization program is stored. In other words, the recording medium according to this embodiment is a non-transitory computer readable tangible medium storing a program.

In a case in which the energy system optimization device according to the present disclosure is configured by installing the energy system optimization program according to the present disclosure in a standalone computer, the energy system optimization program is configured as a single program module and is stored in a predetermined storage area of the computer.

The communication network 1 is an information communication network of at least one of a wired type and a wireless type that transmits communication packets that are compliant with a predetermined communication protocol and, typically, is the Internet in which a plurality of computer networks are interconnected. This communication network 1 may be an intranet that is operated by a single business entity.

The plurality of client terminals 2, the relay server 3, the energy facility database 4, and the optimization calculation device 5 are electrically connected to the communication network 1. This communication network 1 is a communication medium of at least one of a wired type and a wireless type that enables information communication between the plurality of client terminals 2, the relay server 3, the energy facility database 4, and the optimization calculation device 5.

The plurality of client terminals 2 are communication terminals that are managed by individual users who receive an information providing service from the relay server 3. Each client terminal 2 is a communication terminal managed by the respective user and transmits, to the relay server 3 through the communication network 1, an information providing request from the respective user, calculation conditions required by the optimization calculation device 5, and the like. Each client terminal 2 includes a CPU, a storage device, an input/output device, and the like.

In addition, each client terminal 2 receives reply information to the information providing request from the relay server 3 through the communication network 1. The plurality of client terminals 2 include one or more of a stationary-type desktop PC (personal computer), a portable-type notebook PC, a tablet terminal, and the like.

The relay server 3 is a communication server that is managed by a business entity operating the energy system optimization system and is a computer in which the first module is installed and which executes the input step and the output step. This relay server 3 receives the information providing request and the like from the client terminal 2 through the communication network 1 and transmits the reply information acquired from the optimization calculation device 5 to the client terminal 2 through the communication network 1.

The relay server 3 is an information communication device that performs information relay between the plurality of client terminals 2 and the optimization calculation device 5. In other words, in the energy system optimization system, the three functional configuration units (the input unit, the calculation unit, and the output unit) included in the energy system optimization device according to the present disclosure are distributed in the plurality of information communication devices (the plurality of client terminals 2, the relay server 3, and the optimization calculation device 5) that are interconnected through the communication network 1, and thus the convenience of the energy system optimization system and the operation efficiency are improved.

The energy facility database 4, similar to the relay server 3, is a communication device that supports the optimization calculation device 5 and is connected to the communication network 1. This energy facility database 4 includes a storage device that stores attribute information relating to many energy facilities “a” and provides the attribute information for the optimization calculation device 5 in response to a providing request from the optimization calculation device 5.

Here, the attribute information is used for defining features of individual energy facilities “a” among the various types of the energy facilities “a” and includes an input resource that is input to the energy facility “a” and an output resource that is output from the energy facility “a”. In addition, this attribute information also includes characteristic values relating to the input resource and the output resource.

The input resource is a resource input to the energy facility “a”, and the output resource is a resource output from the energy facility “a”. The characteristic value has a concept that represents a relation between the input resource and the output resource, in other words, the characteristics (performance) of the energy facility “a” relating to the input resource and the output resource.

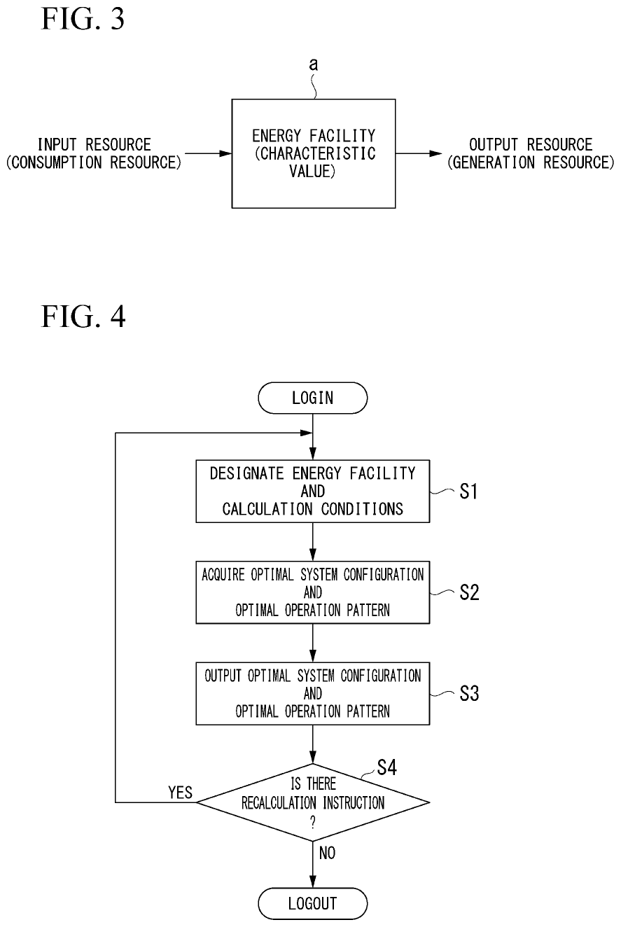

In other words, in this embodiment, as illustrated in FIG. 3, the plurality of types of energy facilities “a” are individually defined by using the input resource, the output resource, and the characteristic value representing the input/output characteristic between the input resource and the output resource.

As illustrated in FIG. 3, the input resource may be referred to as a consumption resource that is consumed by the energy facility “a”. In addition, the output resource may be referred to as a generation resource that is generated by the energy facility “a”.

Since the energy facility “a” includes a battery and the like that can store and discharge a resource (for example, electric power), the consumption resource represents a resource that is consumed or stored by the energy facility “a”, and the generation resource represents a resource that is generated or discharged by the energy facility “a”.

For example, in the gas cogeneration facility a3 as an example of the energy facility “a”, the input resource (consumption resource) is a fuel gas such as town gas, and the output resource (generation resource) is electric power, heat, and carbon dioxide (CO₂).

The optimization calculation device 5 is a computer in which the second module is installed and which executes the calculation step. This optimization calculation device 5 acquires, among system configurations and operation patterns satisfying a predetermined resource demand (demand for the output resource, in other words, demand for the energy system A), an optimal system configuration and an optimal operation pattern for which a system cost is a minimum for the energy system A including the wind power generation facility a1, the water electrolysis facility a2, the gas cogeneration facility a3, the photovoltaic power generation facility a4, and the power storage facility a5.

The system configuration according to this embodiment includes not only the necessity/non-necessity for installation of energy facilities and the number of energy facilities to be installed but also rated outputs, capacities, efficiencies, or the like of the energy facilities. In other words, the acquired optimal system configuration may include necessity/non-necessity for introduction of energy facilities, the number of facilities to be introduced, rated outputs, capacities, efficiency, and the like of the energy facilities.

More specifically, the optimization calculation device 5 acquires an optimal system configuration and an optimal operation pattern for which the system cost of the energy system A is a minimum by solving an optimization problem relating to the energy system A, in other words, by solving a mathematical programming problem formed of a predetermined objective function and constraint conditions. Details of the optimization problem according to this embodiment will be described below as a description of operations.

Next, operations of the energy system optimization system according to this embodiment will be described with reference to a flowchart illustrated in FIG. 4.

First, examples of a user using this energy system optimization system includes a person who has obtained a right to use this system through in-advance registration and a person who has satisfied predetermined use conditions together with payment of a predetermined usage fee. When using this system, the user operates the client terminal 2 to access the relay server 3 and perform transmission/reception of necessary information between the client terminal 2 and the relay server 3, and causes the client terminal 2 to output an optimal system configuration and an optimal operation pattern relating to the designated energy system.

More specifically, when the user operates the client terminal 2 to transmit the information providing request to the relay server 3, the relay server 3 causes the client terminal 2 to display an input screen, which is used for allowing the user to designate the energy facilities “a” configuring the energy system A and calculation conditions. The user sequentially designates the energy facilities “a” and the calculation conditions in accordance with this input screen (Step S1).

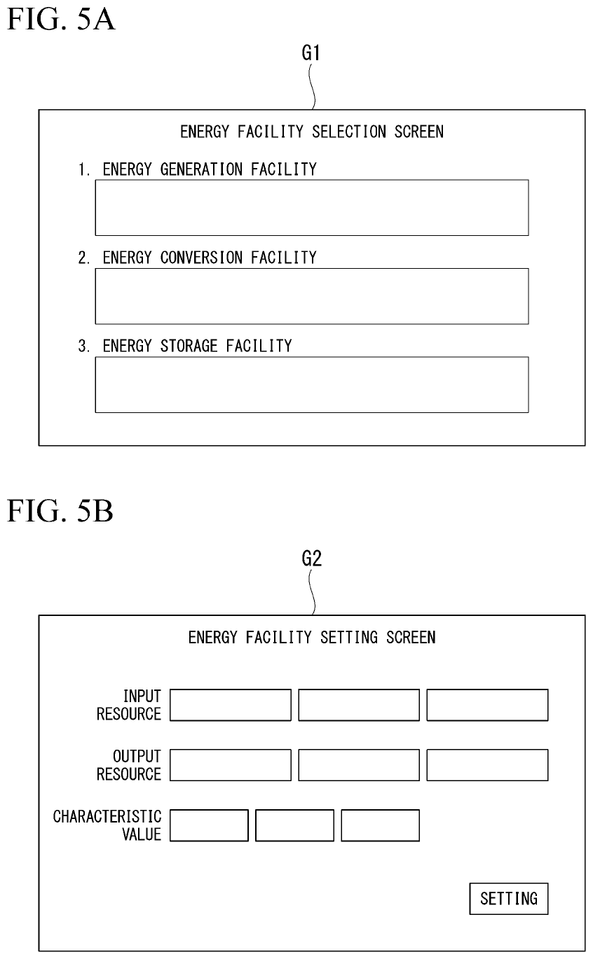

In Step S1, the relay server 3 causes the client terminal 2 to display a designation screen for the energy facilities “a”. For example, as illustrated in FIGS. 5A and 5B, there are an energy facility selection screen G1 and an energy facility setting screen G2 as this designation screen.

The energy facility selection screen G1 is a designation screen for the user to select and designate specific energy facilities “a” among many energy facilities “a” that have been registered in the energy facility database 4 in advance. In the example illustrated in FIG. 5A, on the energy facility selection screen G1, one or more energy facilities “a” can be selected and designated for each type of energy facility “a”, in other words, for each of the energy generation facility (Renewable), the energy conversion facility (Converter), and the energy storage facility (Storage).

The relay server 3 causes to display many energy facilities “a”, which have been registered in the energy facility database 4 in advance, on the energy facility selection screen G1 for each type of energy facility “a” by communicating with the energy facility database 4 through the communication network 1.

On the designation screen, attribute information of the energy facility “a” selected by the user can be freely changed. Specifically, the user requests the relay server 3 to display the attribute information of the energy facility “a” selected by the user, and checks the characteristic values on the designation screen. Then, the user edits the characteristic value on the designation screen, and designates the energy facility “a” after editing the characteristic value as a constituent element of the energy system A.

The energy facility setting screen G2 is a designation screen for designating an input resource (consumption resource), an output resource (generation resource), and a characteristic value for each new energy facility “a” that has not been registered in the energy facility database 4 yet. In the example illustrated in FIG. 5B, the energy facility setting screen G2 is configured such that a maximum of three input resources (consumption resources), three output resources (generation resources), and three characteristic values can be input and set for each energy facility “a”.

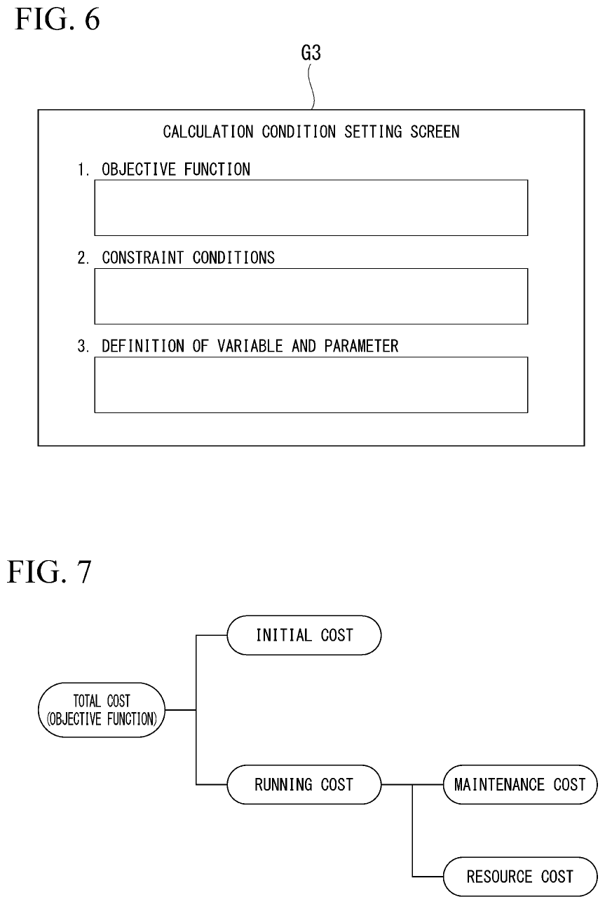

In addition, in Step S1, the calculation conditions are input using a setting screen. This setting screen is necessary for solving the optimization problem (an energy system optimization problem) relating to the energy system A designated on the designation screen and, as in a calculation condition setting screen G3 illustrated in FIG. 6, is used for inputting the objective function and the constraint conditions of the optimization problem and definition information of variables and parameters used in the objective function and the constraint conditions.

The definition information of variables and parameters include information relating to a resource demand expected for the energy system A. This resource demand is input to the client terminal 2 as a necessary amount of an output resource (generation resource) for each predetermined period (for example, one year) and for each of a plurality of unit periods (for example, one day) in the predetermined period.

In other words, in Step S1, the user operates the client terminal 2 to input all of information that is necessary for solving the energy system optimization problem relating to the plurality of types of energy facilities “a”, in other words, the definition information of the energy facilities “a” and the calculation conditions of the optimization problem, to the relay server 3 through the communication network 1.

When the definition information of the energy facilities “a” and the calculation conditions of the optimization problem are input to the relay server 3 in this way, the relay server 3 outputs a calculation instruction for calculating the energy system optimization problem to the optimization calculation device 5 by transmitting the definition information of the energy facilities “a” and the calculation conditions of the energy system optimization problem to the optimization calculation device 5. In accordance with an input of this calculation instruction from the relay server 3 to the optimization calculation device 5, Step S1 is completed.

The optimization calculation device 5 solves the energy system optimization problem on the basis of the calculation instruction, in other words, acquires an optimal system configuration and an optimal operation pattern for which the system cost of the energy system A is a minimum, and in this embodiment, for example, the optimization problem is defined as represented in the following Equations (2) to (29) and Tables 1 to 5B.

In this embodiment, as represented in Equations (2) to (29), the energy system optimization problem is formulated as a mixed integer programming problem. Equations (2) to (29) are numerical expressions that are formulated for a general energy system in which the configuration of an energy facility “a” is not specified.

$$\begin{matrix} [ Math . 2 ] & \\ minimize {f}^{Initial} ( x , y , z ) + {f}_{k}^{Running} ( x , y , z , {s}_{k}^{+} , {s}_{k}^{++} , {s}_{k}^{-} , {s}_{k}^{--} , {ψ}_{k}^{+ Peak} , {ψ}_{k}^{- Peak} ) & ( 2 ) \\ subj . to & \\ [ Math . 3 ] & \\ {x}_{i}^{min} {z}_{i} \leq {x}_{i} \leq {x}_{i}^{max} {z}_{i} , i ∈ , & ( 3 ) \\ [ Math . 4 ] & \\ {y}_{i}^{min} {z}_{i} \leq {y}_{i} \leq {y}_{i}^{max} {z}_{i} , i ∈ 𝒮 , & ( 4 ) \\ [ Math . 5 ] & \\ {z}_{i} \leq {N}_{} , & ( 5 ) \\ [ Math . 6 ] & \\ {r}_{ikl}^{min p} {x}_{i} - ( 1 - {h}_{ikl} ) {x}_{i}^{max} \leq {p}_{ikl} \leq {r}_{ikl}^{max p} {x}_{i} , i ∈ C , k ∈ , l ∈ ℒ , & ( 6 ) \\ [ Math . 7 ] & \\ 0 \leq {p}_{ikl}^{+} \leq {r}_{ikl}^{max p} {x}_{i} , i ∈ 𝒮 , k ∈ , l ∈ ℒ , & ( 7 ) \\ [ Math . 8 ] & \\ 0 \leq {p}_{ikl}^{-} \leq {r}_{ikl}^{max p} {x}_{i} , i ∈ 𝒮 , k ∈ , l ∈ ℒ , & ( 8 ) \\ [ Math . 9 ] & \\ 0 \leq {p}_{ikl}^{-} \leq {r}_{ikl}^{max p} {x}_{i} , i ∈ 𝒮 , k ∈ , l ∈ ℒ , & ( 9 ) \\ [ Math . 10 ] & \\ 0 \leq {p}_{ikl}^{-} \leq {r}_{ikl}^{max p} {x}_{i} , i ∈ 𝒮 , k ∈ , l ∈ ℒ , & ( 10 ) \\ [ Math . 11 ] & \\ 0 \leq {p}_{ikl}^{-} \leq {r}_{ikl}^{max p} {x}_{i} , i ∈ 𝒮 , k ∈ , l ∈ ℒ , & ( 11 ) \\ [ Math . 12 ] & \\ {r}_{ikl}^{min q} {y}_{i} \leq {q}_{ikl} ( {p}_{ik}^{+} , {p}_{ik}^{-} , {q}_{ik0} ) \leq {r}_{ikl}^{max q} {y}_{i} , i ∈ 𝒮 , k ∈ , l ∈ ℒ , & ( 12 ) \\ [ Math . 13 ] & \\ {q}_{ik \vert L - 1 \vert} ( {p}_{ik}^{+} , {p}_{ik}^{-} , {q}_{ik0} ) = {q}_{ik0} , i ∈ 𝒮 , k ∈ , & ( 13 ) \\ [ Math . 14 ] & \\ {s}_{nkl}^{+} \geq 0 , n ∈ , k ∈ , l ∈ ℒ , & ( 14 ) \\ [ Math . 15 ] & \\ {s}_{nkl}^{-} \geq 0 , n ∈ , k ∈ , l ∈ ℒ , & ( 15 ) \\ [ Math . 16 ] & \\ {s}_{nkl}^{++} \geq 0 , n ∈ , k ∈ , l ∈ ℒ , & ( 16 ) \\ [ Math . 17 ] & \\ {s}_{nkl}^{--} \geq 0 , n ∈ , k ∈ , l ∈ ℒ , & ( 17 ) \\ [ Math . 18 ] & \\ {s}_{nkl}^{++} + {s}_{nkl}^{+ max} \geq {s}_{nkl}^{+} , n ∈ , k ∈ , l ∈ ℒ , & ( 18 ) \\ [ Math . 19 ] & \\ {s}_{nkl}^{--} + {s}_{nkl}^{- max} \geq {s}_{nkl}^{-} , n ∈ , k ∈ , l ∈ ℒ , & ( 19 ) \\ [ Math . 20 ] & \\ {ϕ}_{nkl}^{+ Peak} {s}_{nkl}^{+} \leq {ψ}_{nk}^{+ Peak} , n ∈ , k ∈ , l ∈ ℒ , & ( 20 ) \\ [ Math . 21 ] & \\ {ϕ}_{nkl}^{- Peak} {s}_{nkl}^{-} \leq {ψ}_{nk}^{- Peak} , n ∈ , k ∈ , l ∈ ℒ , & ( 21 ) \\ [ Math . 22 ] & \\ {{\sum }_{i ∈ 𝒞}}^{ } {g}_{in} {p}_{ikl} + {\sum }_{i ∈ 𝒮}^{ } {g}_{in} {p}_{ikl}^{-} + {\sum }_{i ∈ ℛ}^{ } {g}_{in} {\overline{r}}_{ikl} {x}_{i} + {s}_{nkl}^{-} = {\sum }_{i ∈ 𝒞} {c}_{in} {p}_{ikl} + {\sum }_{i ∈ 𝒮} {c}_{in} {p}_{ikl}^{+} + {\sum }_{i ∈ ℛ} {c}_{in} {\overline{r}}_{ikl} {x}_{i} + {s}_{nkl}^{+} + {d}_{nkl} \\ n ∈ , k ∈ , l ∈ ℒ , & ( 22 ) \\ [ Math . 23 ] & \\ {z}_{i} ∈ \{ 0 , 1 \} , i ∈ , & ( 23 ) \\ [ Math . 24 ] & \\ {h}_{ikl} ∈ \{ 0 , 1 \} , i ∈ 𝒞 , k ∈ , l ∈ ℒ , & ( 24 ) \\ where & \\ [ Math . 25 ] & \\ {f}^{Initial} ( x , y , z ) = ( {α}_{i}^{0} {x}_{i} + {γ}_{i}^{0} {z}_{i} ) + {\sum }_{i ∈ 𝒮}^{ } {β}_{i}^{0} {y}_{i} , & ( 25 ) \\ [ Math . 26 ] & \\ {f}_{k}^{Running} ( x , y , z , {s}_{k}^{+} , {s}_{k}^{++} , {s}_{k}^{-} , {s}_{k}^{--} , {ψ}_{k}^{+ Peak} , {ψ}_{k}^{- Peak} ) = {f}_{k}^{Maintenance} ( x , y , z ) + {f}_{k}^{Resource} ( {s}_{k}^{+} , {s}_{k}^{++} , {s}_{k}^{-} , {s}_{k}^{--} , {ψ}_{k}^{+ Peak} , {ψ}_{k}^{- Peak} ) , k ∈ , & ( 26 ) \\ [ Math . 27 ] & \\ {f}_{k}^{Maintenance} ( x , y , z ) = {\sum }_{i ∈}^{ } ( {α}_{i}^{k} {x}_{i} + {γ}_{i}^{k} {z}_{i} ) + {\sum }_{i ∈ 𝒮}^{ } {β}_{i}^{k} {z}_{i} , k ∈ , & ( 27 ) \\ [ Math . 28 ] & \\ {f}_{k}^{Resource} ( {s}_{k}^{+} , {s}_{k}^{++} , {s}_{k}^{-} , {s}_{k}^{--} , {ψ}_{k}^{+ Peak} , {ψ}_{k}^{- Peak} ) = DΔT {\sum }_{i ∈ ℒ}^{ } ( {ϕ}_{nkl}^{+} {s}_{nkl}^{+} + {ϕ}_{nkl}^{++} {s}_{nkl}^{++} + {ϕ}_{nkl}^{-} {s}_{nkl}^{-} + {ϕ}_{nkl}^{--} {s}_{nkl}^{--} + D {\sum }_{n ∈ 𝒩}^{ } ( {ψ}_{nk}^{+ Peak} + {ψ}_{nk}^{- Peak} ) , k ∈ , & ( 28 ) \\ [ Math . 29 ] & \\ {q}_{ikl} ( {p}_{ik}^{+} . {p}_{ik}^{-} , {q}_{ik0} ) = {q}_{ik0} + ΔT {\sum }_{m ∈ ℒ , m \leq l}^{ } ( {p}_{ikm}^{+} - {p}_{ikm}^{-} ) , i ∈ 𝒮 , k ∈ , l ∈ ℒ , & ( 29 )\end{matrix}$$

TABLE 1

| No. | SYMBOL | DESCRIPTION |
|---|---|---|
| 1 | [symbol] | SET OF ENERGY FACILITIES |
| 2 | C | SET OF ENERGY CONVERSION FACILITIES |
| | | (Converter) AMONG ENERGY FACILITIES (C ⊆ [symbol] ) |
| 3 | S | SET OF ENERGY STORAGE FACILITIES (Storage) |
| | | AMONG ENERGY FACILITIES (S ⊆ [symbol] ) |
| 4 | [symbol] | SET OF ENERGY GENERATION FACILITIES |
| | | (Renewable) AMONG ENERGY FACILITIES ( [symbol] ⊆ [symbol] ) |
| 5 | [symbol] | SET OF YEARS ( [symbol] = {1 , . . . , \| [symbol] \|) |
| 6 | [symbol] | SET OF HOURS ( [symbol] = {0, 1, . . . , \| [symbol] \|−1) |
| | | (CORRESPONDING TO 0 TO 24 0' CLOCK OF |
| | | REPRESENTATIVE DEMAND PATTERN DAY) |
| 7 | [symbol] | SET OF RESOURCES |

TABLE 2

| No. | SYMBOL | DESCRIPTION |
|---|---|---|
| 1 | D | 365 DAY/YEAR |
| 2 | ΔT | TIME WIDTH [hour] PER TIME STEP |

TABLE 3

| No. | SYMBOL | DESCRIPTION |
|---|---|---|
| 1 | xᵢ | OUTPUT OF ENERGY FACILITY i |
| 2 | yᵢ | CAPACITY OF ENERGY FACILITY (i ∈ S) |
| 3 | zᵢ | zᵢ IS 1 WHEN ENERGY FACILITY IS INTRODUCED AND IS 0 OTHERWISE |
| 4 | pᵢₖₗ | OUTPUT OF ENERGY FACILITY i AT YEAR k AND TIME l (i ∈ C) |
| 5 | hᵢₖₗ | hᵢₖₗ IS 1 WHEN ENERGY FACILITY i IS OPERATED AT YEAR k AND |
| | | TIME l AND IS 0 OTHERWISE (i ∈ C) |
| 6 | pᵢₖₗ⁺ | STORAGE ENERGY OUTPUT OF ENERGY FACILITY i AT YEAR k AND TIME l (i ∈ S) |
| 7 | pᵢₖₗ⁻ | DISCHARGED ENERGY OUTPUT OF ENERGY FACILITY i AT YEAR k AND TIME l |
| | | (i ∈ S) |
| 8 | qᵢₖ₀ | INITIAL VALUE OF REMAINING AMOUNT OF ENERGY STORED IN |
| | | ENERGY FACILITY i AT YEAR k (i ∈ S) |
| 9 | sₙₖₗ⁺ | OUTPUT OF RESOURCE n T0 OUTSIDE OF SYSTEM AT YEAR k AND TIME l |
| 10 | sₙₖₗ⁺⁺ | EXCESS OF ALLOWED OUTPUT IN OUTPUT OF RESOURSE n T0 |
| | | OUTSIDE OF SYSTEM AT YEAR k AND TIME l |
| 11 | Sₙₖₗ⁻⁻ | INPUT OF RESOURCE n FROM OUTSIDE OF SYSTEM AT YEAR k AND TIME l |
| 12 | Sₙₖₗ⁻⁻ | EXCESS OF ALLOWED INPUT IN INPUT OF RESOURCE n FROM OUTSIDE OF |
| | | SYSTEM AT YEAR k AND TIME l |
| 13 | ψₙₖ^{+Peak} | COST FOR MAXIMUM VALUE OF OUTPUT OF RESOURCE n TO OUTSIDE OF |
| | | SYSTEM IN YEAR k (CONVERTED INTO PER DAY) |
| 14 | ψₙₖ^{-Peak} | COST FOR MAXIMUM VALUE OF INPUT OF RESOURCE n FROM OUTSIDE OF |
| | | SYSTEM IN YEAR k (CONVERTED INTO PER DAY) |

TABLE 4

| No. | SYMBOL | DESCRIPTION |
|---|---|---|
| 1 | f^{Initial} | INITIAL INVESTMENT COST OF FACILITY |
| | | INVESTMENT AND THE LIKE |
| 2 | fₖ^{Running} | OPERATION COST IN YEAR k |
| 3 | fₖ^{Maintenance} | MAINTENANCE COST IN YEAR k (COST |
| | | OCCURRING EVEN WHEN ENERGY FACILITY |
| | | IS NOT OPERATED) |
| 4 | fₖ^{Resource} | COST OCCURRING DUE TO DEFICIENCY/EXCESS |
| | | OF RESOURCE IN YEAR k (COST OCCURRING |
| | | BY OPERATING ENERGY FACILITY) |
| 5 | qᵢₖₗ | REMAINING AMOUNT OF ENERGY STORED IN |
| | | ENERGY FACILITY i AT YEAR k AND TIME l (i ∈ S) |

TABLE 5A

| No. | SYMBOL | DESCRIPTION |
|---|---|---|
| 1 | xᵢ^{min} | MINIMUM VALUE OF OUTPUT OF ENERGY FACILITY i |
| 2 | xᵢ^{max} | MAXIMUM VALUE OF OUTPUT OF ENERGY FACILITY i |
| 3 | yᵢ^{min} | MINIMUM VALUE OF CAPACITY OF ENERGY FACILITY i (i ∈ S) |
| 4 | yᵢ^{max} | MAXIMUM VALUE OF CAPACITY OF ENERGY FACILITY i (i ∈ S) |
| 5 | rᵢₖₗ^{minp} | MINIMUM OPERATION OUTPUT OF ENERGY FACILITY i AT |
| | | YEAR k AND TIME l (RATIO TO FACILITY OUTPUT) (i ∈ C) |
| 6 | rᵢₖₗ^{maxp} | MAXIMUM OPERATION OUTPUT OF ENERGY FACILITY i AT |
| | | YEAR k AND TIME l (RATIO TO FACILITY OUTPUT) (i ∈ C) |
| 7 | rᵢₖₗ^{minq} | MINIMUM REMAINING AMOUNT OF ENERGY STORED IN ENERGY FACILITY i AT |
| | | YEAR k AND TIME l (RATIO TO FACILITY CAPACITY) (i ∈ S) |
| 8 | rᵢₖₗ^{maxq} | MAXIMUM REMAINING AMOUNT OF ENERGY STORED IN ENERGY FACILITY i AT |
| | | YEAR k AND TIME l (RATIO TO FACILITY CAPACITY) (i ∈ S) |
| 9 | sₙₖₗ^{+max} | ALLOWED OUTPUT OF RESOURCE n TO OUTSIDE OF SYSTEM AT YEAR k AND TIME l |
| 10 | sₙₖₗ^{-max} | ALLOWED INPUT OF RESOURCE n FROM OUTSIDE OF SYSTEM AT YEAR k AND TIME l |
| 11 | gᵢₙ | GENERATION SPEED OF RESOURCE n WHEN ENERGY FACILITY i IS OPERATED FOR UNIT OUTPUT |
| 12 | cᵢₙ | CONSUMPTION SPEED OF RESOURCE n WHEN ENERGY FACILITY i IS OPERATED FOR UNIT OUTPUT |
| 13 | dₙₖₗ | DEMAND OF RESOURCE n AT YEAR k AND TIME l |
| 14 | [symbol] | OPERATION OUTPUT OF ENERGY FACILITY i AT YEAR k AND |
| | | TIME l (RADIO TO FACILITY OUTPUT) (i ∈ [symbol] ) |
| 15 | αᵢ⁰ | FACILITY INVESTMENT COST OF ENERGY FACILITY i PER UNIT OUTPUT |
| 16 | βᵢ⁰ | FACILITY INVESTMENT COST OF ENERGY FACILITY i PER UNIT CAPACITY (i ∈ S) |
| 17 | γᵢ⁰ | REQUIRED FACILITY INVESTMENT COST REGARDLESS OF SCALE OF ENERGY FACILITY |
| 18 | αᵢ^{k} | MAINTENANCE COST OF ENERGY FACILITY i PER UNIT OUTPUT IN YEAR k |
| 19 | βₗ^{k} | MAINTENANCE COST OF ENERGY FACILITY i PER UNIT CAPACITY IN YEAR k (i ∈ S) |

TABLE 5B

| No. | SYMBOL | DESCRIPTION |
|---|---|---|
| 20 | γᵢ^{k} | REQUIRED MAINTENANCE COST OF ENERGY FACILITY i REGARDLESS OF |
| | | SCALE OF ENERGY FACILITY i IN YEAR k |
| 21 | ϕₙₖₗ⁺ | COST FOR UNIT AMOUNT OF OUTPUT OF RESOURCE n TO OUTSIDE OF SYSTEM AT YEAR k AND TIME l |
| 22 | ϕₙₖₗ⁺⁺ | COST FOR UNIT AMOUNT OF EXCESS OF ALLOWED OUTPUT IN OUTPUT OF RESOURCE n TO |
| | | OUTSIDE OF SYSTEM AT YEAR k AND TIME l (SET TO POSITIVE VALUE) |
| 23 | ϕₙₖₗ⁻ | COST FOR UNIT AMOUNT OF INPUT OF RESOURCE n FROM OUTSIDE OF |
| | | SYSTEM AT YEAR k AND TIME l |
| 24 | ϕₙₖₗ⁻⁻ | COST FOR UNIT AMOUNT OF EXCESS OF ALLOWED INPUT IN INPUT OF RESOURCE n FROM |
| | | OUTSIDE OF SYSTEM AT YEAR k AND TIME l (SET TO POSITIVE VALUE) |
| 25 | ϕₙₖₗ^{+Peak} | COST PER UNIT OUTPUT WHEN MAXIMUM VALUE OF OUTPUT OF RESOURCE n TO OUTSIDE OF |
| | | SYSTEM IS GENERATED AT TIME l AT YEAR k (CONVERTED INTO PER DAY) |
| 26 | ϕₙₖₗ^{-Peak} | COST PER UNIT OUTPUT WHEN MAXIMUM VALUE OF INPUT OF RESOURCE n FROM OUTSIDE OF |
| | | SYSTEM IS GENERATED AT TIME l AT YEAR k (CONVERTED INTO PER DAY) |
| 27 | [symbol] | UPPER LIMIT OF ENERGY FACILITY TO BE INTRODUCED |

Here, Equation (2) is an objective function for minimizing a sum of an initial investment cost and an operation cost in a year. In other words, as illustrated in FIG. 7, the objective function (2) according to this embodiment defines a system cost (total cost) of the energy system A as a total sum of an initial cost (the initial investment cost) and a running cost (the operation cost) and defines the running cost as a total sum of a maintenance cost and a resource cost.

Equations (3) to (29) are conditional equations configuring the constraint conditions of the optimization problem. Among these Equations (3) to (29), Equation (3) shows that an output of an energy facility “a” is within upper and lower limits set in advance, and Equation (4) shows that a capacity of an energy facility “a” is within upper and lower limits set in advance. Equation (5) shows that the number of introduced energy facilities “a” is equal to or less than a number set in advance.

Equations (6) and (7) shows that an operation output of an energy conversion facility (Converter) is “0” or is within upper and lower limits set in advance. Equation (8) shows that a storage energy output of an energy storage facility (Storage) is equal to or less than an upper limit set in advance, and Equation (9) shows that a discharged energy output of an energy storage facility (Storage) is equal to or less than an upper limit set in advance. Equations (10) and (11) show that energy storage and energy discharge cannot be simultaneously performed in the energy storage facility (Storage).

Equation (12) shows that the remaining amount of energy stored in an energy storage facility (Storage) is equal to or less than an upper limit set in advance, and Equation (13) shows that the remaining amount of energy stored in an energy storage facility (Storage) returns to an initial value after one-day operation. Equation (14) shows that an output resource of each resource to the outside of the energy system A takes a non-negative value, and Equation (15) shows that an input resource input from the outside of the energy system A takes a non-negative value.

Equation (16) shows that an excess of an allowed output in an output resource of each resource to the outside of the energy system A takes a non-negative value, and Equation (17) shows that an excess of an allowed input in an input resource input from the outside of the energy system A takes a non-negative value. Equation (18) shows that an excess of an allowed output takes a non-negative value according to the excess amount when an output of each resource to the outside of the energy system A is equal to or more than the allowed output. Equation (19) shows that an excess of an allowed input takes a non-negative value according to the excess amount when an input resource input from the outside of the energy system A is equal to or more than the allowed input.

Equation (20) shows that a cost for a maximum value of an output to the outside of the system is set to a most conservative value over all the time, and Equation (21) shows that a cost for a maximum value of an input from the outside of the system is set to a most conservative value over all the time. Equation (22) shows that balances in an amount of generation, an amount of input, an amount of consumption, an amount of output, and an amount of demand for each resource is achieved at each time of each year.

In other words, the constraint conditions according to this embodiment include the following balance equation (30) formed from an amount U of input of a resource input to the energy system A, an amount G of generation of a resource generated by the energy facility “a”, an amount S of consumption of a resource consumed by the energy facility “a”, an amount J of demand for a resource for the energy system A, and an amount O of output of a resource to the outside of the energy system A.

A first term of the left side of Equation (22) corresponds to the amount (G) of generation of a resource generated by an energy conversion facility. A second term of the left side of Equation (22) corresponds to the amount (G) of generation of a resource generated (discharged) by an energy storage facility. A third term of the left side of Equation (22) corresponds to the amount (G) of generation of a resource generated by an energy generation facility. A fourth term of the left side of Equation (22) corresponds to the amount (U) of input of a resource that is input from the outside of the energy system A. A first term of the right side of Equation (22) corresponds to the amount (S) of consumption of a resource consumed by the energy conversion facility. A second term of the right side of Equation (22) corresponds to the amount (S) of consumption of a resource consumed (stored) by the energy storage facility. A third term of the right side of Equation (22) corresponds to the amount (S) of consumption of a resource consumed by the energy generation facility. A fourth term of the right side of Equation (22) corresponds to the amount (O) of output of a resource to the outside of the energy system A. A fifth term of the right side of Equation (22) corresponds to the amount (J) of demand for a resource for the energy system A.

[Math. 30]

U+G=S+J+O (3)

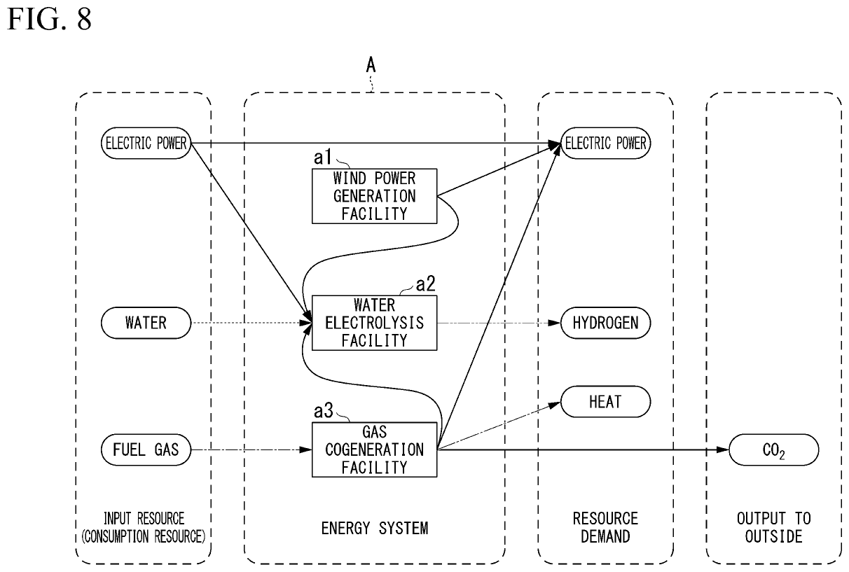

When described using the energy system A illustrated in FIG. 2, for example, the meaning of the balance equation (30) is as represented in FIG. 8. In FIG. 8, for the convenience of description, only the wind power generation facility a1 (an energy generation facility: Renewable), the water electrolysis facility a2 (an energy conversion facility: Converter), and the gas cogeneration facility a3 (an energy conversion facility: Converter) are illustrated among the five energy facilities “a” configuring the energy system A.

In other words, when the wind power generation facility a1, the water electrolysis facility a2, and the gas cogeneration facility a3 are considered, the input resources (consumption resources) are electric power and water consumed by the water electrolysis facility a2 and a fuel gas consumed by the gas cogeneration facility a3.

In addition, in a case in which the resource demand expected by consumers to be supplied by the energy system A is electric power that is output resources (generation resources) of the wind power generation facility a1 and the gas cogeneration facility a3, hydrogen that is an output resource (generation resource) of the water electrolysis facility a2, and a heat that is an output resource (generation resource) of the gas cogeneration facility a3, carbon dioxide (CO₂) that is an output resource (generation resource) of the gas cogeneration facility a3 does not have a demander and is separately output to the outside.

When Equations (22) and (30) are set as the constraint conditions of the energy system optimization problem, electric power that is output resources (generation resources) of the wind power generation facility a1 and the gas cogeneration facility a3 is provided for a demander, and also used as an input resource (consumption resource) of the water electrolysis facility a2 as illustrated in FIG. 8, and part of electric power that is an input resource (consumption resource) is supplied to a demander as an output resource (generation resource).

Equation (23) shows that a parameter denoted as No. 3 in Table 3 takes one of values “0” and “1”. Equation (24) shows that a parameter denoted as No. 5 in Table 3 takes one of values “0” and “1”.

Equation (25) is a definition equation of an initial investment cost, and Equation (26) is a definition equation of an operation cost. Equation (27) is a definition equation of a maintenance cost, and Equation (28) is a definition equation of a cost occurring due to excess or deficiency of resources. Equation (29) is a definition equation of a remaining amount of energy stored in an energy storage facility (Storage).

The optimization calculation device 5 acquires an optimal system configuration and an optimal operation pattern relating to the energy system A by solving the energy system optimization problem formulated by Equations (2) to (29) and Tables 1 to 5B. The process of acquiring an optimal system configuration and an optimal operation pattern in the optimization calculation device 5 is a process of Step S2 in this embodiment and corresponds to the calculation step according to the present disclosure.

In this calculation step, information of the energy facilities designated in the input step (for example, types of the energy facilities (an energy generation facility, an energy conversion facility, or an energy storage facility), types of consumption resources and generation resources, and characteristic values relating to the consumption resource and the generation resource) is used, and this information may be information of the energy facility designated in the input step by performing at least one of selection of energy facilities registered in advance and setting of a consumption resource, a generation resource, and a characteristic value relating to the consumption resource and the generation resource of a new energy facility. In addition, this information may include a new characteristic value acquired in the input step by changing the characteristic value of the energy facility registered in advance.

In other words, an initial investment cost (initial cost) can be acquired by solving the energy system optimization problem, and this initial investment cost includes configuration information of the energy facilities “a” configuring the energy system, in other words, includes the optimal system configuration. Thus, the optimization calculation device 5 acquires an optimal system configuration as transaction information of the initial investment cost (initial cost) by solving the energy system optimization problem.

By solving the energy system optimization problem, an operation cost (running cost) can be acquired simultaneously with the initial investment cost (initial cost), and this operation cost (running cost) includes an optimal operation pattern of each energy facility “a” for a predetermined period (for example, one year) and a plurality of unit periods (for example, one day) in the predetermined period.

The optimization calculation device 5 transmits the optimal system configuration and the optimal operation pattern to the relay server 3. Then, the relay server 3 transmits the optimal system configuration and the optimal operation pattern to the client terminal 2 as reply information to the information providing request that has been received in advance from the client terminal 2.

In other words, when the optimal system configuration and the optimal operation pattern are received from the optimization calculation device 5, the relay server 3 edits the optimal system configuration and the optimal operation pattern into an output format requested by the client terminal 2 and transmits them to the client terminal 2. As a result, the optimal system configuration and the optimal operation pattern are output to the client terminal 2.

A series of processes in which the optimization calculation device 5 transmits the optimal system configuration and the optimal operation pattern to the relay server 3, and the optimal system configuration and the optimal operation pattern are output to the client terminal 2 is a process of Step S3 according to this embodiment and corresponds to the output step according to the present disclosure. In this output step, at least part of information of the energy facilities designated in the input step (for example, types of the energy facilities (an energy generation facility, an energy conversion facility, or an energy storage facility), types of consumption resources and generation resources, and characteristic values relating to the consumption resource and the generation resource) may be output, and this information may be information of the energy facility designated in the input step by performing at least one of selection of energy facilities registered in advance and setting of a consumption resource, a generation resource, and a characteristic value relating to the consumption resource and the generation resource of a new energy facility. In addition, this information may include a new characteristic value acquired in the input step by changing the characteristic value of the energy facility registered in advance.

The user checks the optimal system configuration and the optimal operation pattern output to the client terminal 2 and, in a case in which reacquisition of an optimal system configuration and an optimal operation pattern for changed calculation conditions is desired, inputs a reacquisition request (a recalculation request) to the client terminal 2. When the recalculation request is input from the client terminal 2, the relay server 3 performs reacquisition of an optimal system configuration and an optimal operation pattern by transmitting the calculation conditions (recalculation conditions) included in the recalculation request to the optimization calculation device 5.

In other words, when the user inputs the recalculation request to the client terminal 2, the relay server 3 determines recalculation of an optimal system configuration and an optimal operation pattern (Step S4), and, as a result, the processes of Steps S1 to S3 are repeated.

Here, in a case in which the information providing request, which is received before the recalculation request, requests provision of one of an optimal system configuration and an optimal operation pattern, the relay server 3 transmits the one of the optimal system configuration and the optimal operation pattern to the client terminal 2 in response to the information providing request. In other words, the energy system optimization system according to this embodiment outputs at least one of the optimal system configuration and the optimal operation pattern to the user in response to the user's request.

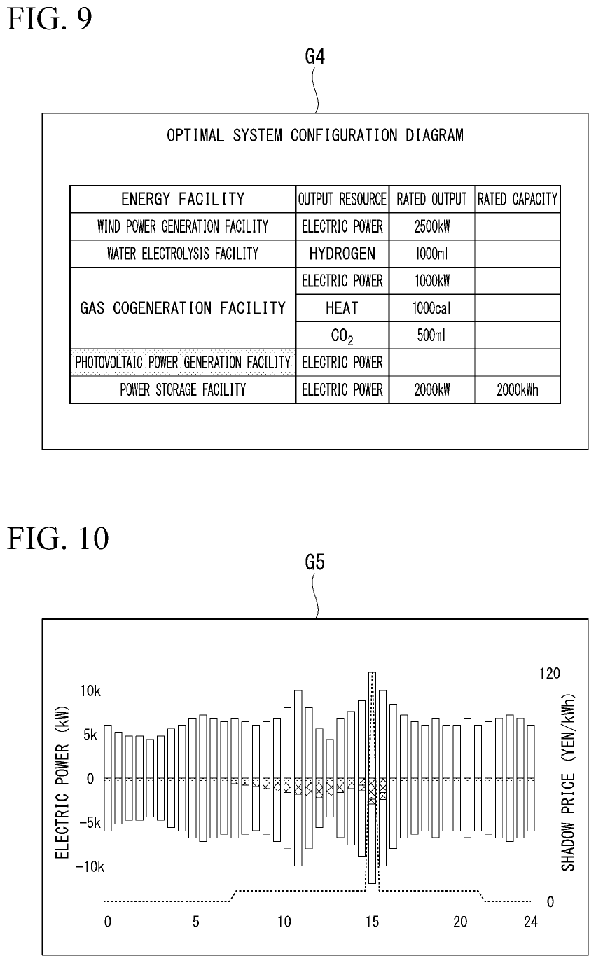

FIG. 9 is a schematic diagram illustrating one example of the optimal system configuration displayed in the client terminal 2. In FIG. 9, among the five energy facilities “a” designated in Step S1 by the user, the photovoltaic power generation facility a4 is displayed in a gray-out state, and for the remaining four energy facilities “a”, in other words, the wind power generation facility a1, the water electrolysis facility a2, the gas cogeneration facility a3, and the power storage facility a5, the rated output and the rated capacity that satisfy the resource demand and can minimize the system cost (total cost) are displayed for each output resource (generation resource).

In other words, among the plurality of types of energy facilities “a” designated in the input step (Step S1), energy facilities (the energy facilities “a”, in other words, the wind power generation facility a1, the water electrolysis facility a2, the gas cogeneration facility a3, and the power storage facility a5) included in the optimal system configuration and an energy facility (the photovoltaic power generation facility a4) not included in the optimal system configuration are displayed (output) in different forms in the output step (Step S3).

In the optimal system configuration illustrated in FIG. 9, it is represented that, when using the wind power generation facility a1, the water electrolysis facility a2, the gas cogeneration facility a3, and the power storage facility a5, except for the photovoltaic power generation facility a4, among the five energy facilities “a” designated in the input step (Step S1) by the user, the resource demand is satisfied, and the system cost (total cost) can be minimized. In the optimization system configuration of FIG. 9, facility performances, in other words, rated outputs and rated capacities, requested for the wind power generation facility a1, the water electrolysis facility a2, the gas cogeneration facility a3, and the power storage facility a5 are illustrated.

FIG. 10 is a schematic diagram illustrating one example of an optimal operation pattern display screen displayed in the client terminal 2. On this optimal operation pattern display screen, as to the optimal system configuration including the four energy facilities “a” described above, an operation pattern of each energy facility “a”, which satisfies the resource demand and can minimize the system cost (total cost), is represented as an output of each output resource (generation resource) for each day (each unit period) in one year (a predetermined period).

On this optimal operation pattern display screen, among time variations of various output resources (generation resources) in the optimal system configuration in one year (predetermined period), the time variation of electric power (output resource) in a certain one day (unit period) is represented in an enlarged scale. Furthermore, on this optimal operation pattern display screen, a resource demand (electric power demand) for electric power (output resource) is represented as a positive value, and an output of the electric power of the optimal system configuration with respect to this resource demand (electric power demand) is represented as a negative value.

In addition, on this optimal operation pattern display screen, a shadow price for the resource demand for electric power (output resource) is displayed together. This shadow price is a quantity that represents sensitivity for the cost of the electric power (output resource). On this optimal operation pattern display screen, the shadow price has an extremely large value near 15 o'clock, and this is due to the fact that demand for the electric power near 15 o'clock is maximal in one day.

According to this embodiment, since a plurality of types of energy facilities “a” can be designated in the input step (Step S1), it is possible to provide an energy system optimization system capable of handling the energy system A including the plurality of types of energy facilities “a”.

In addition, according to this embodiment, in the input step (Step S1), since energy facilities “a” are selected using the energy facility selection screen G1, and input resources, output resources, and characteristic values are set using the energy facility setting screen G2, designation of a plurality of types of energy facilities “a” can be performed easily and accurately.

In addition, according to this embodiment, since characteristic values of the energy facilities “a” selected using the energy facility selection screen G1 can be freely changed, the energy facilities “a” that have been registered in advance can be utilized in a flexible manner. Furthermore, according to this embodiment, an optimal system configuration and an optimal operation pattern having high reliability can be obtained by solving the energy system optimization problem.

In addition, according this embodiment, since a balance equation of resources as represented in Equation (22) is set as a constraint condition in formulating the energy system optimization problem, a total system cost of the energy system A can be minimized.

In addition, according to this embodiment, since the system cost (total cost) of the energy system A is defined as a total sum of the initial cost (initial investment cost) and the running cost (operation cost) of the energy system A, not only one but both of the initial investment cost and the operation cost can be minimized.

Furthermore, according to this embodiment, since the running cost (the operation cost) is defined as a total sum of the maintenance cost of the energy system A and the resource cost relating to resources, not only one but both of the maintenance cost and the resource cost can be minimized.

In addition, according to this embodiment, in the output step (Step S3), time variations of the input resource and the output resource of the energy facility “a” in a predetermined period and a unit period are output, and thus a user can accurately perceive the operation status of each energy facility “a” in the optimal system configuration.

Furthermore, according to this embodiment, in the output step (Step S3), among the plurality of types of energy facilities “a” designated in the input step (Step S1), an energy facility included in the optimal system configuration and an energy facility not included in the optimal system configuration are output in different forms, in other words, are displayed in different display forms such as a normal display and a gray-out display, and therefore the energy facility included in the optimal system configuration and the energy facility not included in the optimal system configuration can be easily distinguished.

In addition, according to this embodiment, since a shadow price for a resource demand is output in the output step (Step S3), a resource demand for which the shadow price is the highest can be easily perceived.

Furthermore, according to this embodiment, since three types of energy facilities “a”, in other words, the energy generation facility, the energy conversion facility, and the energy storage facility are designated in the input step (Step S1), an optimal system configuration and an optimal operation pattern of an energy system A including the three types of energy facilities “a” can be obtained.

The present disclosure is not limited to the embodiments described above, and, for example, modifications as below may be considered.

(1) In the above-described embodiment, the energy system A including five energy facilities “a”, in other words, the wind power generation facility a1, the water electrolysis facility a2, the gas cogeneration facility a3, the photovoltaic power generation facility a4, and the power storage facility a5 has been described, but the present disclosure is not limited thereto. The energy system A may include an energy facility other than the five energy facilities “a” or may not include any one or all of the five energy facilities “a”.

The present disclosure enables a plurality of types of energy facilities “a” such as an energy generation facility (Renewable), an energy conversion facility (Converter), and an energy storage facility (Storage) to be handled at the same time when at least one of an optimal system configuration and an optimal operation pattern is acquired by enabling designation of the plurality of types of energy facilities “a”. Thus, in the present disclosure, an energy system to be actually handled may include a plurality of types of energy facilities “a”, or may include a single type of energy facilities.

In addition, the types of energy facilities “a” according to the present disclosure are not limited to the energy generation facility (Renewable), the energy conversion facility (Converter), and the energy storage facility (Storage). For example, different types of facilities may be included as long as the facilities are energy facilities “a” that can be defined using input resources (consumption resources), output resources (generation resources), and characteristic values.

(2) In the above-described embodiment, the energy facility database 4 and the optimization calculation device 5 are directly connected to the communication network 1, but the present disclosure is not limited thereto. The energy facility database 4 and the optimization calculation device 5 can function as long as they can basically communicate only with only the relay server 3 and thus, may be connected only to the relay server 3 using predetermined dedicated communication lines.

(3) In the above-described embodiment, examples of the energy facility selection screen G1 and the energy facility setting screen G2 are illustrated in FIGS. 5A and 5B, and an example of the calculation condition setting screen G3 is illustrated in FIG. 6, but the present disclosure is not limited thereto. The designation method (the designation screen) for a plurality of types of energy facilities according to the present disclosure is not limited to that illustrated in FIGS. 5 and 6, and any other designation method may be used.

(4) In the above-described embodiment, an example of the optimal system configuration diagram G4 is illustrated in FIG. 9, and an example of the optimal operation pattern display screen G5 is illustrated in FIG. 10, but the present disclosure is not limited thereto. The method of outputting the optimal system configuration and the optimal operation pattern according to the present disclosure is not limited to that illustrated in FIGS. 9 and 10, and any other output method may be used.

(5) In the above-described embodiment, formulation of the energy system optimization problem is performed as Equations (2) to (29), but the present disclosure is not limited thereto. The objective function according to the present disclosure is not limited to Equation (2), and the constraint conditions are not limited to Equations (3) to (29).

For example, in the above-described embodiment, the objective function (a total cost) is defined as a sum of the initial cost (initial investment cost) and the running cost (operation cost), but the present disclosure is not limited thereto. As is necessary, the objective function (total cost) may be defined as any one of the initial cost (initial investment cost) and the running cost (operation cost).

In addition, in the above-described embodiment, the running cost (operation cost) is defined as a sum of the maintenance cost and the resource cost, but the present disclosure is not limited thereto. As is necessary, any one of the maintenance cost and the resource cost may be defined as the running cost (operation cost).

In addition, the constraint conditions according to the present disclosure include the balance equation formed from the amount U of input of a resource (input resource) input to the energy system A, the amount G of generation of a resource (generation resource) generated by the energy facility “a”, the amount S of consumption of a resource (consumption resource) consumed by the energy facility “a”, the amount J of demand for a resource for the energy system A, and the amount O of output of a resource (output resource) to the outside of the energy system A as represented in Equations (22) and (30), but this balance equation is not essential. Conditional equations different from Equations (22) and (30) may be employed as the constraint conditions.

(6) In the above-described embodiment, at least one of an optimal system configuration and an optimal operation pattern for which the system cost of the energy system A is a minimum is acquired by the optimization calculation device 5 (or the calculation step or the calculation process), but the present disclosure is not limited thereto. At least one of an optimal system configuration and an optimal operation pattern for which a predetermined index is minimal may be acquired among at least one of the system configuration and the operation pattern of the energy system A satisfying a predetermined demand. Examples of this index include the amount of discharge of CO₂ or the amount of discharge of heat from the energy system A, the system cost of the energy system A, and the like.

(7) The objective function according to the above-described embodiment defines the system cost (total cost) of the energy system A as a total sum of the initial cost (initial investment cost) and the running cost (operation cost) and defines the running cost as a total sum of the maintenance cost and the resource cost, but the present disclosure is not limited thereto. The objective function of the present disclosure may define the system cost of the energy system A as a weighted sum of the initial cost and the running cost and may define the running cost as a weighted sum of the maintenance cost and the resource cost. One of weighting factors may be set to zero. For example, in a case in which one of the weighting factors of the initial cost and the running cost is set to zero, the other cost is used as the system cost. In a case in which one of the weighting factors of the maintenance cost and the resource cost is set to zero, the other cost is used as the running cost.

(8) The objective function according to the above-described embodiment defines the resource cost as an input resource input to the energy system A, but the present disclosure is not limited thereto. Since the amount of output resources output from the energy system A leads to an increase/decrease in the cost (for example, an increase in the processing cost, a purchase of an emission quota of CO₂, and the like), the objective function may define the resource cost as an output resource output from the energy system A or may define the resource cost as a weighted sum of an input resource input to the energy system A and an output resource output from the energy system A.

In addition, the present disclosure includes the following aspects in addition to the aspects described above.

A fifteenth aspect of the present disclosure is a non-transitory computer-readable recording medium storing an energy system optimization program causing a computer to execute processes of predetermined steps, the steps including: an input step of designating a plurality of types of energy facilities configuring an energy system; a calculation step of acquiring at least one of an optimal system configuration and an optimal operation pattern for which a predetermined index is minimal among at least one of system configurations and operation patterns of the energy system satisfying a predetermined demand; and an output step of outputting the at least one of the optimal system configuration and the optimal operation pattern.

A sixteenth aspect of the present disclosure is an energy system optimization device that includes: an input unit configured to designate a plurality of types of energy facilities configuring an energy system; a calculation unit configured to acquire at least one of an optimal system configuration and an optimal operation pattern for which a predetermined index is minimal among at least one of system configurations and operation patterns of the energy system satisfying a predetermined demand; and an output unit configured to output the at least one of the optimal system configuration and the optimal operation pattern.

A seventeenth aspect of the present disclosure is a recording medium storing an energy system optimization program causing a computer to execute processes of predetermined steps, the steps including: an input step of designating a plurality of types of energy facilities configuring an energy system; a calculation step of acquiring at least one of an optimal system configuration and an optimal operation pattern for which a predetermined index is minimal among at least one of system configurations and operation patterns of the energy system satisfying a predetermined demand; and an output step of outputting the at least one of the optimal system configuration and the optimal operation pattern.

According to the present disclosure, an energy system optimization technology capable of handling an energy system including a plurality of types of energy facilities can be provided.

What is claimed is:

1. A non-transitory computer-readable recording medium storing an energy system optimization program causing a computer to execute processes of predetermined steps,
the steps comprising:
an input step of designating a plurality of types of energy facilities configuring an energy system;
a calculation step of acquiring at least one of an optimal system configuration and an optimal operation pattern for which a predetermined index is minimal among at least one of system configurations and operation patterns of the energy system satisfying a predetermined demand; and
an output step of outputting the at least one of the optimal system configuration and the optimal operation pattern.

2. The non-transitory computer-readable recording medium according to claim 1,
wherein, in the calculation step, the optimal operation pattern is acquired by solving an optimization problem including an objective function representing a minimum of the index and predetermined constraint conditions, and
wherein, in the input step, the objective function and the constraint conditions are designated.

3. The non-transitory computer-readable recording medium according to claim 2, wherein a system cost is used as the index.

4. The non-transitory computer-readable recording medium according to claim 3, wherein the system cost is a weighted sum of an initial cost and a running cost of the energy system.

5. The non-transitory computer-readable recording medium according to claim 4, wherein the running cost is a weighted sum of a maintenance cost of the energy system and a resource cost relating to at least one of an input resource input to the energy system and an output resource output from the energy system.

6. The non-transitory computer-readable recording medium according to claim 2, wherein the constraint conditions include the following Equation (1) that is formed from an amount U of input of a resource input to the energy system, an amount G of generation of a resource generated by the energy facility, an amount S of consumption of a resource consumed by the energy facility, an amount J of demand for a resource for the energy system, and an amount O of output of a resource to outside of the energy system.
[Math. 1]
U+G=S+J+O (1)

7. The non-transitory computer-readable recording medium according to claim 1, wherein, in the input step, the energy facility is designated by performing at least one of selection of energy facilities registered in advance and setting of a consumption resource and a generation resource of a new energy facility and a characteristic value relating to the consumption resource and the generation resource.

8. The non-transitory computer-readable recording medium according to claim 7, wherein, in the input step, the characteristic value of the energy facilities registered in advance is changeable.

9. The non-transitory computer-readable recording medium according to claim 1,
wherein, in the output step, time variations of a resource input to the energy system and a demand for the energy system are output for a predetermined period of the energy facility and a plurality of unit periods in the predetermined period, and
wherein, in the input step, the predetermined period and the unit period are further input.

10. The non-transitory computer-readable recording medium according to claim 1, wherein, in the output step, among the plurality of types of energy facilities designated in the input step, an energy facility included in the optimal system configuration and an energy facility not included in the optimal system configuration are output in different forms.

11. The non-transitory computer-readable recording medium according to claim 1, wherein, in the output step, a shadow price for the demand is further output.

12. The non-transitory computer-readable recording medium according to claim 1, wherein, in the input step, two or more types of energy facilities among an energy generation facility generating various forms of energy, an energy conversion facility converting a certain form of energy into a different form of energy, and an energy storage facility internally storing energy supplied from outside are designated.

13. An energy system optimization method comprising:
an input process of designating a plurality of types of energy facilities configuring an energy system;
a calculation process of acquiring at least one of an optimal system configuration and an optimal operation pattern for which a predetermined index is minimal among at least one of system configurations and operation patterns of the energy system satisfying a predetermined demand; and
an output process of outputting the at least one of the optimal system configuration and the optimal operation pattern.

14. An energy system optimization device comprising:
at least one memory storing instructions and at least one processor configured to execute the instructions to:
designate a plurality of types of energy facilities configuring an energy system;
acquire at least one of an optimal system configuration and an optimal operation pattern for which a predetermined index is minimal among at least one of system configurations and operation patterns of the energy system satisfying a predetermined demand; and
output the at least one of the optimal system configuration and the optimal operation pattern.
